(19) United States
(12) Patent Application Publication
(10) Pub. No.: US 2011/0253277 A1
(43) Pub. Date: Oct. 20, 2011

(54) POLYURETHANE OR POLYURETHANE-UREA TIRE FILLINGS PLASTICIZED WITH FATTY ACID ESTERS

(76) Inventors: Gerhard Mueller, Adlington (GB); Vincenzo Luciano D'Ignoti, Correggio (RE) (IT); Verena M.T. Thiede, Muenster (DE); Christoph Juris, Hamm (DE); Carlo Cocconi, Correggio (IT)

(21) Appl. No.: 13/141,814

(22) PCT Filed: Jan. 7, 2010
(86) PCT No.: PCT/US10/20293

§ 371 Date: Jun. 23, 2011

Related U.S. Application Data
(60) Provisional application No. 61/143,192, filed on Jan. 8, 2009.

(51) Int. Cl. B60C 7/00; B29D 30/02

(52) U.S. Cl. 152/310; 427/230

(57) ABSTRACT

A tire filling material comprises a polyurethane or polyurethane-urea elastomer that is extended with a C₁-C₄ ester of one or more fatty acids. The fatty acid esters are compatible with the elastomer and with the reactive materials that are used to make the elastomer. The tire filling material is soft and has physical properties that are suitable for tire filling applications.

This application claims priority from U.S. Provisional Patent Application No. 61/143,192, filed 8 Jan. 2009.

This invention relates to polyurethane compositions for filling tires, and to tires filled with polyurethane compositions.

Pneumatic tires are commonly used in on-road vehicles such as automobiles and trucks. Pneumatic tires have the advantages of being light in weight and providing a soft and comfortable ride, because the tire casing is filled with a gas. The main disadvantage of pneumatic tires is the risk of deflation due to punctures, separation of the tire casing from the rim, or other failure of the tire casing or rim. For on-road vehicles, this risk is generally small because road surfaces tend to be reasonably clean and smooth. Tire failure and consequent deflation is a much greater concern for off-road vehicles, largely due to an increased risk of puncture but also because of a greater possibility of unseating the tire from the rim. It also tends to be more difficult to change or repair a tire on an off-road vehicle. This can be because the vehicle and its tires are extremely large, as is the case with tractors and large construction or earth-moving vehicles; because of the lack of readily available spare tires or air compressing equipment; or because the vehicle is at a remote location at the time of the tire failure.

For these reasons, many off-road vehicles use filled tires rather than pneumatic tires. The casing of a filled tire contains a solid or semi-solid material instead of a compressed gas. This reduces or eliminates the risk of deflation, as a puncture or other failure of the tire casing will not lead to an escape of gas.

A tire fill material should meet several requirements. The tire fill material should allow the tire to absorb shock and provide good traction. Therefore, the tire fill material should be soft and flexible. In addition, the tire fill material should be such that the tire does not build up excessive heat during use, as the heat can damage the fill material or the casing and thus diminish the useful life of the tire. The tire fill material preferably does not contain a liquid or gas phase which can leak out if the casing is damaged. The tire fill material preferably is capable of being introduced easily into the tire while in a field setting (rather than being restricted to a factory setting). In addition, cost is a very important concern, especially with larger tires which sometimes contain a metric ton or more of the tire fill material.

Soft polyurethane/urea elastomers have been used as a tire fill material. Seveal approaches along these lines have been tried. In some cases, the polyurethane/urea polymer has been foamed using carbon dioxide that is generated in a reaction between water and an organic isocyanate. Such an approach is described in U.S. Pat. No. 3,605,848. These foams have the advantages of light weight due to their cellular nature, and of being very soft. However, the foams tend to exhibit high hysteresis and high heat build-up. In addition, some deflation can be seen when the tire casing is deflated, due to the escape of the gas that is contained in the cells of the foam.

Another approach, described, for example in GB 2,137,639, is to fill the tire with a water-in-oil urethane emulsion. The emulsion contains a large excess of water above that needed to cure the polymer. The function of the excess water is to act as a diluent in order to reduce cost, and to absorb carbon dioxide that is generated as the system cures. This at least partially eliminates a gas phase from the tire fill material. However, the excess water forms a liquid phase that can leak from the tire if the tire casing fails.

Yet another approach uses a non-cellular, highly plasticized polyurethane or polyurethane-urea elastomer as the tire fill material. Because the fill material is non-cellular, these materials tend to exhibit less hysteresis than do cellular fill materials, and for that reason experience less heat build-up. The elastomer is the reaction product of a polyisocyanate, a polyol material and a small amount of a chain extender. In order to achieve the requisite softness, the elastomer is filled with a large quantity of an extending oil. Among the various types of extender oils mentioned for use in this application are chlorinated paraffins, various diesters such as dioctyl phthalate, dibutyl diglycol adipate, diisodecyl succinate, diisodecyl adipate, dioctyl azelate, dibutyl sebacate and dioctyl sebacate; and aromatic extender oils. GB 1,552,120 and U.S. Pat. Nos. 4,230,168, 5,402,839 and 6,187,125 describe this general approach. Among the extender oils, the aromatic extender oils have been found to be commercially practical.

The aromatic extender oils are coming under regulatory pressure in various countries, notably in Europe, where they are suspected carcinogens. With the potential loss of these materials, a new tire fill material is needed. A new tire fill material should deliver a performance that approximates or exceeds that of the aromatic oil-extended polyurethane elastomer, and preferably makes use of readily available materials that are available at reasonable cost.

This invention is in certain respects a filled tire comprising a tire casing which is filled with an elastomeric filling material, wherein said elastomeric filling material includes a polyurethane or polyurethane-urea elastomer extended with a C₁-C₄ alkyl ester of one or more fatty acids. These C₁-C₄ alkyl esters of one or more fatty acids are sometimes referred to herein by the shorthand term “fatty acid ester extenders”.

It has been found that a C₁-C₄ alkyl ester of one or more fatty acids functions very well as an extender or plasticizer for the elastomeric filling material. The elastomeric filling material containing this type of extender has several advantageous properties. These include elongation, compression and resiliency values that tend to be similar to those of elastomeric tire filling materials that contain aromatic extender oils. Tensile and tear strengths tend to be somewhat greater. The elastomeric filling material of the invention tends to be somewhat harder than similar aromatic oil-extended systems, at an equivalent elongation and resilience. The fatty acid ester extender used in the invention can be prepared from starting materials that are widely available, and which in many cases have the additional benefit of being derived from annually renewable resources such as various species of plants.

The fatty acid ester extenders also tend to be highly compatible with the polyurethane or polyurethane-urea portion of the elastomeric filling material. For that reason, the extenders do not tend to phase separate strongly from the rest of the composition to produce a significant volume of a liquid phase inside the tire casing. The compatibility of the fatty acid ester extenders is especially good when the polyurethane or polyurethane-urea elastomer is made using certain hydroxymethyl-containing polyester polyols, as are described in more detail below. This good compatibility allows high levels of the extender to be used, which can reduce the overall cost of the tire filling material as well as make the filling material softer.

The invention is also a process for preparing a filled tire comprising introducing into a tire casing a reactive composition that contains a C₁-C₄ alkyl ester of one or more fatty acids, and curing said reactive composition inside the tire casing to form a polyurethane or polyurethane-urea elastomer.

The invention is in other aspects a process for making a polyisocyanate-terminated prepolymer, comprising (a) blending an organic polyisocyanate with a C₁-C₄ alkyl ester of one or more fatty acids, (b) exposing the resulting blend to conditions sufficient to cause the organic isocyanate to react with hydroxyl-containing species in the C₁-C₄ alkyl ester of one or more fatty acids, and, simultaneously with or after step (b), (c) reacting the organic isocyanate with at least one polyol that has a hydroxyl equivalent weight of at least 300 to form the isocyanate-terminated prepolymer.

Prepolymers made via this process have low amounts of sedimentation, tend to be storage-stable, and are resistant to phase separation even when the prepolymer contains large proportions of the fatty acid ester extender.

The elastomeric filling material of the invention includes a polyurethane or polyurethane-urea elastomer that is extended with a fatty acid ester extender. The filling material may in addition contain one or more filler materials, which can be included to reduce cost or provide certain beneficial properties.

The fatty acid ester extender is a methyl, ethyl, n-propyl, isopropyl, n-butyl, sec-butyl, isobutyl or t-butyl ester of one or more linear monocarboxylic acids that contains (including the carbonyl carbon of the carboxylic acid group) from 12 to 30 carbon atoms. Methyl esters are preferred on the basis of their easy synthesis and availability. The linear monocarboxylic acid(s) preferably contain from 12 to 24 carbon atoms and more preferably from 12 to 20 carbon atoms. The linear monocarboxylic acid(s) may contain one or more sites of carbon-carbon unsaturation, or may be saturated. The linear monocarboxylic acid(s may) contain inert substituent groups such as hydroxyl, halogen, nitro and the like. Preferred fatty acid ester extenders have melting temperatures of 10° C. or lower.

The linear carboxylic acids may be a mixture of the constituent fatty acids of one or more vegetable oils. Suitable such fatty acids include the constituent fatty acids of canola (rapeseed) oil, castor oil, citrus seed oil, cocoa butter, corn oil, cottonseed oil, hemp oil, lard, linseed oil, oat oil, olive oil, palm oil, peanut oil, rapeseed oil, rice bran oil, safflower oil, sesame oil, soybean oil or sunflower oil. The constituent fatty acids of most vegetable oils are mixtures of two or more linear monocarboxylic acids that may differ in chain length, substituents and/or the number of unsaturation sites. The content of a fatty acid mixture obtained in any particular case will depend on the particular plant species that is the source of the oil or fat, and to a lesser extent may depend on the geographical source of the oil as well as the time of year in which the oil has been produced and other growing conditions. Fatty acids are conveniently obtained from a starting vegetable oil by a hydrolysis reaction, which produces the fatty acids and glycerine.

A preferred fatty acid ester extender is a C₁-C₄ alkyl ester of a mixture of the constituent fatty acids of canola (rapeseed) and soy oils.

A fatty acid mixture obtained from a vegetable oil may be purified to isolate one or more of the constituent fatty acids, if a more defined material is desired.

A C₁-C₄ alkyl ester of a fatty acid or fatty acid mixture can be prepared from a fatty acid by reaction of the fatty acid or mixture with the corresponding alcohol. Alternatively, a fatty acid ester extender can be obtained directly by reaction of the oil with a C₁-C₄ alcohol.

The polyurethane or polyurea elastomer is an organic polymer that contains urethane groups or both urethane and urea groups. An “elastomer”, for purposes of this invention, is a material that, when stretched to 150% of its original length (i.e., extended by 50%) and released, returns with force to essentially its initial length. The elastomer should be a relatively soft material. When extended with the fatty acid ester extender, the elastomer should have a Shore A hardness of 30 or less, preferably 20 or less.

The polyurethane or polyurethane-urea elastomer typically is the reaction product of at least one organic polyisocyanate with one or more high (i.e. >300) equivalent weight polyol materials. At least one chain extender will be used to form the elastomer in most cases. It is also possible to incorporate a crosslinker into the formulation. The proportions of the starting materials are selected to provide a soft elastomeric polymer, which should have a Shore A hardness of 30 or less when extended with the fatty acid ester extender.

The extended polyurethane or polyurethane urea elastomer suitably has one or more of the following properties:

(a) Shore A hardness per ASTM D2240 of less than 30, preferably less than 20;
(b) Elongation at break per ISO 527-3 from 200% to 500%, preferably from 300% to 400%;
(c) Tensile strength per ISO 527-3 of at least 0.3 N/mm², preferably at least 1.0 N/mm² and even more preferably from 1.0 to 2 N/mm²;
(d) Compression set per ASTM D395 of from 25 to 75%, preferably from 40 to 60%;
(e) Ball rebound per ASTM D3574 of at least 30%, preferably from 40 to 70%;
(f) Tear strength per DIN 53543 of at least 0.4 N/mm, preferably at least 0.8 N/mm and more preferably at least 1.5 N/mm; and
(g) Density of from 750 to 1250 kg/m³, preferably from 850 to 1100 kg/m³. The extended polyurethane or polyurethane-urea elastomer may possess any two or more of these properties in combination, and may possess all of these properties in combination.

The polyurethane or polyurethane-urea elastomer is formed by forming a reactive composition containing a fatty acid ester extender as described above, and curing that reactive composition within a tire casing. Methods of forming polyurethane elastomers within a tire casing are well known and described, for example, in GB 1,552,120, U.S. Pat. No. 5,402,839 and U.S. Pat. No. 6,187,125. The tire casing may or may not be affixed to a rim or wheel at the time the filling material is introduced and cured. In most cases, the tire will be mounted onto a rim or wheel, and the reactive composition will be introduced into the casing through one or more openings in the rim, the wheel or the tire casing.

The reactive composition contains reactive components that react to form a polyurethane or polyurea elastomer. These include at least one organic polyisocyanate, at least one high (>300 g/eq.) equivalent weight polyol, and optionally one or more chain extenders and/or crosslinkers. Some or all of these may be present in the form of intermediates that are formed by reaction of some subset of these materials beforehand. The reactive composition may in addition contain various optional materials, such as catalysts, fillers, blowing agents, surfactants, preservatives, biocides, antioxidants and the like, as described more below.

The reactive composition is formed by mixing the starting materials, including the fatty acid ester extender. This can be done by bringing the components together all at once or by forming various subcombinations before bringing the components together. It is usually preferred to formulate the starting materials into two components, one of which contains isocyanate-reactive materials and the other of which contains the polyisocyanate(s). Chain extenders and crosslinkers are conveniently pre-mixed with at least a portion of the high equivalent weight polyol beforehand to produce a formulated polyol component.

The fatty acid ester extender may be pre-mixed into the polyisocyanate, into any of the high equivalent weight materials, and/or into a formulated polyol component before forming the final reactive composition. Often, a portion of the fatty acid ester extender is premixed into a formulated polyol component, and another portion is premixed with the polyisocyanate. This is often convenient for balancing the volumes of the respective mixtures, which allows for simplified metering and handling.

It is generally preferred to introduce the polyisocyanate in the form of a prepolymer, as this allows part of the curing reaction to take place beforehand and also helps to balance the volumes of the starting components. The prepolymer is formed by reacting the polyisocyanate with a portion of the isocyanate-reactive materials. An excess of polyisocyanate is used so that the resulting prepolymer is isocyanate-terminated. The prepolymer can be prepared in conventional manner by mixing the starting materials and heating them until a constant isocyanate content is attained. The prepolymer suitably has an isocyanate content of from 2 to 25% by weight, which corresponds to an isocyanate equivalent weight of from 168 to 2100.

Such a prepolymer is preferably prepared by reaction of the polyisocyanate with a portion of the high equivalent weight polyol. Some or all of the chain extenders and/or crosslinkers (if any) also can be incorporated into the prepolymer, but it is generally preferably to omit these from the prepolymer.

Some or all of the fatty acid ester extender can be incorporated into a prepolymer, if desired. A preferred way of doing this is to blend the polyisocyanate with the fatty acid ester extender and subjecting the resulting blend to conditions sufficient to cause the organic isocyanate to react with isocyanate-reactive species in the fatty acid ester extender, such as residual water, glycerine, amines and the like. The organic isocyanate is simultaneously or subsequently reacted with at least part of the high equivalent weight polyol to form the prepolymer. This process produces prepolymers that have low amounts of sedimentation, tend to be highly storage-stable, and are resistant to phase separation even when the prepolymer contains large proportions of the fatty acid ester extender.

Once all the components of the reactive composition are blended together and introduced into the tire casing, the reactive composition cures to form an extended polyurethane or polyurethane-urea elastomer. Heat can be applied to the reactive composition to drive the cure, but it is often inconvenient to do so once the reactive composition has been introduced into the tire casing. The various components can be preheated before mixing and introduced into the mold while still warm. Alternatively, the components can be mixed together at the ambient temperature and cured with or without applying additional heat. Cure times can range form a few minutes to many hours, depending on the temperature conditions, use of catalysts, the reactivity of the starting materials, and the size of the tire casing.

As the reactive composition cures, the fatty acid ester extender becomes dissolved or dispersed in the resulting elastomer and plasticizes it.

Suitable organic polyisocyanates for making the elastomer are materials or mixtures of materials that have an average of at least 1.8 isocyanate groups per molecule. The polyisocyanate may have up to 4 isocyanate groups per molecule, on average. A preferred range is from 2.0 to 3.2 isocyanate groups per molecule. In some embodiments, it has been found that polyisocyanates that have somewhat low isocyanate functionalities, such as an average of from 2.0 to 2.25 isocyanate groups per molecule, can be used with good results.

The polyisocyanate may be an aromatic, cycloaliphatic and aliphatic type, although aromatic types are preferred on the basis of low cost and ready availability. Exemplary polyisocyanates include m-phenylene diisocyanate, toluene-2,4-diisocyanate, toluene-2.6-diisocyanate, isophorone diisocyanate, 1,3- and/or 1,4-bis(isocyanatomethyl)cyclohexane (including cis- or trans-isomers of either), hexamethylene-1,6-diisocyanate, tetramethylene-1,4-diisocyanate, cyclohexane-1,4-diisocyanate, hexahydrotoluene diisocyanate, methylene bis(cyclohexaneisocyanate) (H₁₂MDI), naphthylene-1,5-diisocyanate, methoxyphenyl-2,4-diisocyanate, diphenylmethane-4,4′-diisocyanate, diphenylmethane-2,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), toluene-2,4,6-triisocyanate and 4,4′-dimethyldiphenylmethane-2,2′,5,5′-tetraisocyanate. Preferably the polyisocyanate is MDI (i.e., diphenylmethane-4,4′-diisocyanate, diphenylmethane-2,4′-diisocyanate or a mixture thereof), PMDI or a mixture of MDI and PMDI.

Derivatives of any of the foregoing polyisocyanates, especially MDI, that contain biuret, urea, carbodiimide, allophonate and/or isocyanurate groups can also be used.

A high equivalent weight polyol, for purposes of this invention, is a material having an average of at least 1.5 hydroxyl groups per molecule and a hydroxyl equivalent weight of at least 300. The high equivalent weight polyol preferably contains an average of from 1.8 to 3.0 hydroxyl groups per molecule. The hydroxyl equivalent is preferably at least 400, more preferably at least 600, to about 8,000, more preferably to about 3,000 and still more preferably to about 2,000.

Examples of suitable high equivalent weight materials include polyether polyols, polyester polyols, hydroxyl-containing vegetable oils such as castor oil, and various polyols that are derivatives of vegetable oils, animal fats, or one or more fatty acids. Hydroxyl-containing vegetable oils and polyols that are derivatives of vegetable oils or one or more fatty acids are preferred in some cases, because the extending oil often tends to be highly compatible with elastomers that are made from these types of polyols. A polyol is a “derivative” of a vegetable oil or fatty acid if it contains at least one chain of 12 to 30 carbon atoms having a carbonyl carbon at one end of the chain, which chain of carbon atoms was present in the starting vegetable oil or fatty acid. The chain of 12 to 30 carbon atoms may contain one or more substituents or modifications that are introduced in the process of converting the fatty acid into a polyol, such as, for example, hydroxyl or hydroxymethyl groups as described more fully below.

Polyether polyols of interest include homopolymers of propylene oxide, ethylene oxide or tetrahydrofuran, for example, and random and/or block copolymers of propylene oxide and ethylene oxide. Among these, propylene oxide homopolymers and random or block copolymers of propylene oxide and ethylene oxide which contain up to 15% by weight polymerized ethylene oxide are preferred. Polyester polyols of interest include polylactones and butanediol/adipate polyesters.

There are several useful types of hydroxyl-containing derivatives of vegetable oils, animal fats or one or more fatty acids that have an equivalent weight and functionality as stated above. For example, US Published Patent Applications 2002/0121328, 2002/0119321 and 2002/0090488 describe certain transesterified “blown” vegetable oils which are useful herein. These polyols are prepared by “blowing” a vegetable oil to introduce hydroxyl groups at the sites of carbon-carbon unsaturation on the constituent fatty acid chains, and then transesterifying the blown vegetable oil with glycerine or other multifunctional polyol to produce a polyol product.

Vegetable oil-based polyols such as are described in GB 1,248,919 can be used. These polyols are prepared in the reaction of a vegetable oil with an alkanolamine (such as triethanolamine) to form a mixture of monoglycerides, diglycerides and reaction products of the alkanolamine and fatty acids from the vegetable oil. These materials have free hydroxyl groups on the glycerine and alkanolamine portions of the molecules. These free hydroxyl groups are ethoxylated to increase reactivity and to provide a somewhat more hydrophilic character.

Amides of hydroxymethylated fatty acids with alkanolamines, such as are described in Khoe et al., “Polyurethane Foams from Hydroxymethylated Fatty Diethanolamides”, J. Amer. Oil Chemists' Society 50:331-333 (1973), are also useful.

An especially preferred high equivalent weight polyol is a hydroxymethyl-containing polyester polyol (HMPP) which is derived from a fatty acid. The HMPP is characterized as having at least one ester group per molecule and at least one hydroxymethyl (—CH₂OH) group per molecule. The HMPP is conveniently obtained using as a starting material a hydroxymethyl-group containing fatty acid having from 12 to 30 carbon atoms, or an ester of such a hydroxymethylated fatty acid. It can be prepared by reacting the hydroxymethyl-group containing fatty acid (or ester) with a polyol, hydroxylamine or polyamine initiator compound having an average of at least 1, preferably at least about 2 hydroxyl, primary amine and/or secondary amine groups/molecule, as described in WO 04/096744. Proportions of starting materials and reaction conditions are selected such that the resulting HMPP contains an average of at least 1.3 repeating units obtained from the hydroxmethyl-group containing fatty acid or ester thereof for each hydroxyl, primary amine and secondary amine group in the initiator compound, and the HMPP has an equivalent weight of at least 300 up to about 15,000. Equivalent weight is equal to the number average molecular weight of the molecule divided by the combined number of hydroxyl, primary amine and secondary amine groups.

The HMPP suitably has an average of at least 2, preferably at least 2.5, more preferably at least 2.8, to about 12, more preferably to about 6, even more preferably to about 5, hydroxyl, primary and secondary amine groups combined per molecule. The HMPP also suitably has an equivalent weight of at least 400, such as at least about 600, at least about 650, at least about 700, or at least about 725, to about 15,000, such as to about 6000, to about 3500, up to about 1700, up to about 1300, or to about 1000.

The HMPP advantageously is a mixture of compounds having the following average structure:

[H—X]_{(z-p)}—R—[X—Z]ₚ (I)

wherein R is the residue of an initiator compound having z hydroxyl and/or primary or secondary amine groups, where z is at least two; each X is independently —O—, —NH— or —NR′— in which R′ is an inertly substituted alkyl, aryl, cycloalkyl, or aralkyl group, p is a number from 1 to z representing the average number of [X—Z] groups per hydroxymethyl-containing polyester polyol molecule, Z is a linear or branched chain containing one or more A groups, provided that the average number of A groups per molecule is ≧1.3 times z, and each A is independently selected from the group consisting of A1, A2, A3, A4 and A5, provided that at least some A groups are A1, A2 or A3. A1 is:

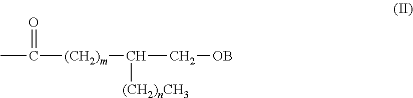

wherein B is H or a covalent bond to a carbonyl carbon atom of another A group; m is number greater than 3, n is greater than or equal to zero and m+n is from 8 to 22, especially from 11 to 19. A2 is:

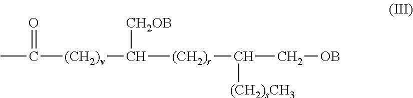

wherein B is as before, v is a number greater than 3, r and s are each numbers greater than or equal to zero with v+r+s being from 6 to 20, especially 10 to 18. A3 is:

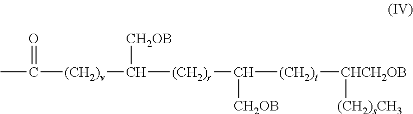

wherein B, v, each r and s are as defined before, t is a number greater than or equal to zero, and the sum of v, r, s and t is from 5 to 18, especially from 10 to 18. A4 is

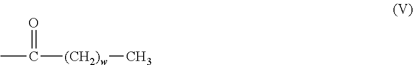

where w is from 10-24, and A5 is

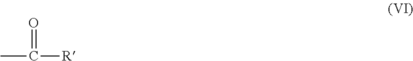

where R′ is a linear or branched alkyl group that is substituted with at least one cyclic ether group and optionally one or more hydroxyl groups or other ether groups. The cyclic ether group may be saturated or unsaturated and may contain other inert substitution. The hydroxyl groups may be on the alkyl chain or on the cyclic ether group, or both. The alkyl group may include a second terminal —C(O)— or —C(O)O— group through which it may bond to another initiator molecule. A5 groups in general are lactols, lactones, saturated or unsaturated cyclic ethers or dimers that are formed as impurities during the manufacture of the hydroxylmethyl-group containing fatty acid or ester. A5 groups may contain from 12 to 50 carbon atoms.

In formula I, z is preferably from 2 to 8, more preferably from 2 to 6, even more preferably from 2 to 5 and especially from about 3 to 5. Each X is preferably —O—. The total average number of A groups per hydroxymethylated polyol molecule is preferably at least 1.5 times the value of z, such from about 1.5 to about 10 times the value of z, about 2 to about 10 times the value of z or from about 2 to about 5 times the value of z.

A is preferably A1, a mixture of A1 and A2, a mixture of A1 and A4, a mixture of A1, A2 and A4, a mixture of A1, A2 and A3, or a mixture of A1, A2, A3 and A4, in each case optionally containing a quantity of A5. Mixtures of A1 and A2 preferably contain A1 and A2 groups in a mole ratio of 10:90 to 95:5, particularly from 60:40 to 90:10. Mixtures of A1 and A4 preferably contain A1 and A4 groups in a mole ratio of 99.9:0.1 to 70:30, especially in a ratio of from 99.9:0.1 to 85:15. Mixtures of A1, A2 and A4 preferably contain from about 10 to 95 mole percent A1 groups, 5 to 90 percent A2 groups and up to about 30 percent A4 groups. More preferred mixtures of A1, A2 and A4 contain from 25 to 70 mole-% A1 groups, from 15 to 40% A2 groups and up to 30% A4 groups. Mixtures of A1, A2 and A3 preferably contain from 30 to 80 mole-% A1, from 10 to 60% A2 and from 0.1 to 10% A3 groups. Mixtures of A1, A2, A3 and A4 groups preferably contain from 20 to 50 mole percent A1, 1 to about 65 percent A2, from 0.1 to about 10 percent A3 and up to 30 percent A4 groups. Especially preferred polyester polyols of the invention contain a mixture of from 20 to 50% A1 groups, from 20 to 50% A2 groups, 0.5 to 4% A3 groups and from 15 to 30% A4 groups. In all cases, A5 groups advantageously constitute from 0 to 7%, especially from 0 to 5%, of all A groups.

Preferred mixtures of A groups conveniently contain an average of about 0.8 to about 1.5 —CH₂OH and —CH₂OB groups/A group, such as from about 0.9 to about 1.3 —CH₂OH and/or —CH₂OB groups/A group or from about 0.95 to about 1.2 —CH₂OH and/or —CH₂OB groups/A group. Such mixtures of A groups (1) allow the initiator functionality to mainly determine the polyeter polyol functionality and (2) tend to form less densely branched polyester polyols.

“Inertly substituted” groups on the HMPP are groups that do not react with an isocyanate groups and which do not otherwise engage in side reactions during the preparation of the hydroxymethyl-group containing polyester polyol. Examples of such inert substituents include as aryl, cycloalkyl, silyl, halogen (especially fluorine, chlorine or bromine), nitro, ether, ester, and the like.

In formula (I), R represents the residue, after removal of hydroxyl and/or amino groups, of a material that contains two or more hydroxyl, primary amine or secondary amine groups. Polyols are initiators of particular interest. Polyether polyol initiators are useful, including polymers of ethylene oxide and/or propylene oxide having from 2 to 8, especially 2 to 4 hydroxyl groups/molecule and a molecular weight of from 150 to 3000, especially from 200 to 1000. Suitable lower (i.e., less than 300, preferably from 31 to 125 g/eq.) equivalent weight initiators include ethylene glycol, diethylene glycol, 1,2-propylene glycol, dipropylene glycol, tripropylene glycol, cyclohexanedimethanol, ethylene diamine, phenylene diamine, bis(3-chloro-4-aminophenyl)methane, 2,4-diamino-3,5-diethyl toluene, diethanol amine, monoethanol amine, triethanol amine, mono- di- or tri(isopropanol) amine, glycerine, trimethylol propane, pentaerythritol, and the like.

The HMPP may contain some unreacted initiator compound, and may contain unreacted hydromethylated fatty acids (or esters).

The HMPP may be alkoxylated if desired to introduce polyether chains onto one or more of the hydroxymethyl groups or functional groups attached to the residue of the initiator compound.

A chain extender may be present in the reactive composition that forms the elastomer. A chain extender is a material having two isocyanate-reactive groups per molecule and an equivalent weight per isocyanate-reactive group of less than 300, preferably less than 200 and especially from 31 to 125. The isocyanate reactive groups are preferably hydroxyl, primary aliphatic or aromatic amino or secondary aliphatic or aromatic amino groups. Representative chain extenders include ethylene glycol, diethylene glycol, triethylene glycol, 1,2-propylene glycol, dipropylene glycol, tripropylene glycol, 1,4-butanediol, cyclohexane dimethanol, ethylene diamine, phenylene diamine, bis(3-chloro-4-aminophenyl)methane, dimethylthiotoluenediamine and diethyltoluenediamine.

One or more crosslinkers also may be present in the reactive composition that forms the elastomer. For purposes of this invention, “crosslinkers” are materials having three or more isocyanate-reactive groups per molecule and an equivalent weight per isocyanate-reactive group of less than 300. Crosslinkers preferably contain from 3 to 8, especially from 3 to 4 hydroxyl, primary amine or secondary amine groups per molecule and have an equivalent weight of from 30 to about 200, especially from 50 to 125. Examples of suitable crosslinkers include diethanol amine, monoethanol amine, triethanol amine, mono- di- or tri(isopropanol) amine, glycerine, trimethylol propane, pentaerythritol, and the like.

The proportions of the polyisocyanate, high equivalent weight polyol(s), chain extenders and crosslinkers are selected to produce a soft, elastomeric polymer. The amount of polyisocyanate is typically expressed by the “isocyanate index”, which is 100 times the ratio of isocyanate groups in the reactive composition divided by the number of isocyanate-reactive groups in the reactive composition. The isocyanate index is suitably from 70 to 130, and more preferably from 85 to 120. A higher isocyanate index tends to lead to forming a harder elastomer, whereas a lower index tends to lead to an undercured polymer that has poor tensile and tear properties.

Chain extenders and crosslinkers are suitably used in somewhat small amounts, as hardness increases as the amount of either of these materials increases. From 0 to 25 parts by weight of a chain extender is suitably used per 100 parts by weight of the high equivalent weight polyol(s). A preferred amount is from 1 to 15 parts per 100 parts by weight of the high equivalent polyol(s). From 0 to 10 parts by weight of a crosslinker is suitably used per 100 parts by weight of the high equivalent weight polyol(s). A preferred amount is from 0 to 5 parts per 100 parts by weight of the high equivalent polyol(s).

The fatty acid ester extender is present in an amount such that the Shore A hardness of the extended elastomer is 30 or less on the A scale. If too much of the fatty acid ester extender is present, it can leach from the elastomer and form a separate liquid phase. A suitable amount of extender is an amount such that the extender constitutes from 25 to 65% by weight of the total weight of the extended elastomer.

One or more catalysts is preferably present in the reactive composition to accelerate the cure rate and to help complete the polymerization reaction. However, the amount of catalyst should be small enough that a useful open time is provided before the reactive composition becomes too viscous to flow easily into the tire casing. Generally the amount and type of the catalyst(s) are selected in conjunction with the other starting materials and anticipated reaction conditions to provide an open time of at least one minute, and more preferably at least 10 minutes. For filling very large tire casings, an open time of 30 minutes or more may be desired.

A wide variety of materials are known to catalyze polyurethane forming reactions, including tertiary amines, tertiary phosphines, various metal chelates, acid metal salts, strong bases, various metal alcoholates and phenolates and metal salts of organic acids. Catalysts of most importance are organotin catalysts and tertiary amine catalysts, which can be used singly or in some combination.

Examples of suitable organotin catalysts are stannic chloride, stannous chloride, stannous octoate, stannous oleate, dimethyltin dilaurate, dibutyltin dilaurate, dibutyl tin dioctoate, other organotin compounds of the formula SnRₙ(OR)₄₋ₙ, wherein R is alkyl or aryl and n is from 0 to 2, mercaptotin catalysts, and the like.

Examples of suitable tertiary amine catalysts include: trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts can be used. Examples of suitable commercially available amine catalysts include Niax™ A1 (bis(dimethylaminoethyl)ether in propylene glycol available from GE OSi Silicones), Niax™ B9 (N,N-dimethylpiperazine and N—N-dimethylhexadecylamine in a polyalkylene oxide polyol, available from GE OSi Silicones), Dabco™ 8264 (a mixture of bis(dimethylaminoethyl)ether, triethylenediamine and dimethylhydroxyethyl amine in dipropylene glycol, available from Air Products and Chemicals), Dabco™ 33S(triethylene diamine in 1,4-butanediol, available from Air Products and Chemicals), and Dabco™ 33LV (triethylene diamine in dipropylene glycol, available from Air Products and Chemicals), Niax™ A-400 (a proprietary tertiary amine/carboxylic salt and bis(2-dimethylaminoethy)ether in water and a proprietary hydroxyl compound, available from GE OSi Silicones); Niax™ A-300 (a proprietary tertiary amine/carboxylic salt and triethylenediamine in water, available from GE OSi Specialties Co.); Polycat™ 58 (a proprietary amine catalyst available from Air Products and Chemicals), Polycat™ 5 (pentamethyl diethylene triamine, available from Air Products and Chemicals) and Polycat™ 8 (N,N-dimethyl cyclohexylamine, available from Air Products and Chemicals).

Organotin catalysts are typically used in small amounts, such as from 0.001 to 0.03 parts, preferably 0.05 to 0.015 parts, per 100 parts by weight high equivalent weight polyol(s). Tertiary amine catalysts are generally used in somewhat greater amounts, such as from 0.05 to about 5, especially from about 0.25 to about 2 parts per 100 parts by weight high equivalent weight polyol(s).

A filler may be present in the reactive composition. Fillers are mainly included to reduce cost. A preferred type of filler is an elastomeric or semi-elastomeric material which does not provide significant hardness to the extended elastomer. Particulate rubbery materials are especially useful fillers. Among these are rubber crumb, ground recycled tire casings or ground recycled elastomeric tire fill material. Such a filler may constitute from 1 to 50% or more of the weight of the reactive composition.

If a cellular tire filling is desired, the reactive composition may contain a blowing agent. However, it is generally preferred to produce a substantially non-cellular tire filling material that has a density of at least 750 kg/m³. Suitable blowing agents include water, air, nitrogen, argon, carbon dioxide and various hydrocarbons, hydrofluorocarbons and hydrochlorofluorocarbons.

A surfactant may be present in the reaction mixture. It can be used, for example, if a cellular tire filling is desired, as the surfactant stabilizes a foaming reaction mixture until it can harden to form a cellular polymer. A surfactant also may be useful to wet filler particles and thereby help disperse them into the reactive composition and the elastomer. Silicone surfactants are widely used for this purpose and can be used here as well. Examples of such silicone surfactants are commercially available under the tradenames Tegostab™ (Th. Goldschmidt and Co.), Niax™ (GE OSi Silicones) and Dabco™ (Air Products and Chemicals). The amount of surfactant used will in general will be between 0.02 and 1 part by weight per 100 parts by weight high equivalent weight polyol(s).

The invention is applicable to filling a wide range of tires that can be used in many applications. The tires can be, for example, for a bicycle, a cart such as a golf cart or shopping cart, a motorized or unmotorized wheelchair, an automobile or truck, any other type of transportation vehicles including an aircraft, as well as various types of agriculture, industrial and construction equipment. Large tires that have an internal volume of 0.1 cubic meter or more are of particular interest.

The following examples are provided to illustrate the invention, but are not intended to limit the scope thereof. All parts and percentages are by weight unless otherwise indicated.

### EXAMPLES 1-4

An isocyanate-terminated prepolymer is prepared by mixing 11.8 parts of MDI with 13.63 parts of a carbodiimide modified MDI having an isocyanate equivalent weight of 143, and heating the mixture to 70° C. under nitrogen. 0.3 parts of an antioxidant (Irganox™ 1076 from CIBA) and 0.02 part of benzyol chloride are added, and the mixture is heated under nitrogen. 40.21 parts of a mixture of fatty acid methyl esters is then added over 30 minutes, while maintaining the reaction temperature. The fatty acid methyl ester mixture contains 50% of methyl esters of rapeseed fatty acids and 50% of methyl esters of soy oil fatty acids. The resulting mixture is heated at 70° C. under nitrogen for 30 minutes, and then 34.36 parts of a 2000 equivalent weight poly(propylene oxide) triol are added over 30 minutes, again under nitrogen and while maintaining the temperature at 70° C. The mixture is again heated under nitrogen until a prepolymer having an isocyanate content of 6.4% is obtained. The resulting prepolymer contains about 40% by weight of the fatty acid ester extender.

The prepolymer is divided into portions. A first portion is exposed to artificial light for 5 days at 60° C. This portion is designated Prepolymer 1-A. A second portion (Prepolymer 1-B) is exposed to air for two hours. A third portion (Prepolymer 1-C) is maintained under nitrogen until used to make an elastomer. The aged samples (Prepolymers 1-A and 1-B) become somewhat cloudy as a result of the aging.

A formulated polyol is prepared as follows: 89.32 parts by weight of a 2000 equivalent weight, trifunctional poly(propylene oxide), 10 parts of monoethylene glycol, 0.64 parts of a tertiary amine catalyst and 0.035 parts by weight of an organotin catalyst are blended together. 40 parts by weight of the resulting blend are then mixed with 60 parts by weight of the same fatty acid ester mixture as is used in making the prepolymer.

The reactivities of each of Prepolymers 1-A, 1-B and 1-C are evaluated by separately combining equal weights of the formulated polyol with each of the prepolymers. The components are mixed together for one minute at 20° C., and the gel time of the curing mixture is measuring on a TECHNE model GT6 Gelation Timer.

Extended elastomer Examples 1-A, 1-B and 1-C are prepared by separately hand mixing equal weights of Prepolymers 1-A, 1-B and 1-C, respectively with the formulated polyol at room temperature, pouring the mixture onto plastic plates and allowing them to cure at room temperature. The resulting elastomers are then evaluated for tensile strength, elongation at break, tear strength, ball rebound, compression set and hardness. Results are as indicated in Table 1.

TABLE 1

| Test | Ex. 1-A | Ex. 1-B | Ex. 1-C |
|---|---|---|---|
| Gel time, minutes | 20-25 | 20-25 | 20-25 |
| Tensile Strength, ISO 527-3, N/mm² | 0.91 | 1.13 | 1.05 |
| Elongation at break, ISO 527-3, % | 293 | 345 | 369 |
| Tear Strength, DIN 53543, N/mm | 1.50 | 1.57 | 1.05 |
| Ball Rebound, ASTM D3574, % | 34 | 34 | 40 |
| Compression Set, ASTM D395, % | 36 | 35 | 28 |
| Shore A Hardness, ASTM D2240 | 4 | 5 | 5 |

Examples 2-A, 2-B and 2-C are made in the same manner except for how the prepolymer is made. For these samples, the order of addition of the poly(propylene oxide) triol and the fatty acid ester is reversed. The poly(propylene oxide) triol is added to the isocyanate/antioxidant/benzoyl chloride mixture and allowed to react to an isocyanate content of about 6.4%, after which the mixture of fatty acid ester is added, followed by heating at 70° C. for about 30 minutes. The prepolymer is then divided into portions and either aged under light for 5 days at 60° C. (Prepolymer 2-A), for 2 hours under air (Prepolymer 2-B) or not aged (Prepolymer 2-C). The aged samples (Prepolymers 2-A and 2-B) become somewhat cloudy as a result of the aging. Elastomer Examples 2-A, 2-B and 2-C are made from Prepolymers 2-A, 2-B and 2-C, respectively, in the same manner as described with respect to Examples 1-A, 1-B and 1-C. Gel time is measured as before, with results as indicated in Table 2. Duplicate test samples are prepared as before, and physical property testing is performed as before, with results as indicated in Table 2.

TABLE 2

| Test | Ex. 2-A | Ex. 2-B | Ex. 2-C |
|---|---|---|---|
| Gel time, minutes | 20-25 | 20-25 | 20-25 |
| Tensile Strength, ISO 527-3, N/mm² | 1.13 | 1.02 | 0.73 |
| Elongation at break, ISO 527-3, % | 372 | 350 | 225 |
| Tear Strength, DIN 53543, N/mm | 1.23 | 1.41 | 1.19 |
| Ball Rebound, ASTM D3574, % | 43 | 42 | 41 |
| Compression Set, ASTM D395, % | 30 | 39 | 30 |
| Shore A Hardness, ASTM D2240 | 6 | 5 | 5 |

Examples 3-A, 3-B and 3-C are made in the same manner as Examples 1-A, 1-B and 1-C, respectively, with the following change in which the prepolymer is made. For these samples, the poly(propylene oxide) triol and the fatty acid ester mixture are added simultaneously to the isocyanate/antioxidant/benzoyl chloride mixture and allowed to react to an isocyanate content of about 6.4%. The prepolymer is then divided into portions and either aged under light for 5 days at 60° C. (Prepolymer 3-A), for 2 hours under air (Prepolymer 3-B) or not aged (Prepolymer 3-C). The aged samples (Prepolymers 3-A and 3-B) become somewhat cloudy as a result of the aging. Elastomer Examples 3-A, 3-B and 3-C are made from Prepolymers 3-A, 3-B and 3-C, respectively, in the same manner as described with respect to Examples 1-A, 1-B and 1-C. Gel time is measured as before, and physical property testing is performed as before, with results as indicated in Table 3.

TABLE 3

| Test | Ex. 3-A | Ex. 3-B | Ex. 3-C |
|---|---|---|---|
| Gel time, minutes | 20-25 | 20-25 | 20-25 |
| Tensile strength, ISO 527-3, N/mm² | 1.42 | 1.21 | 0.81 |
| Elongation at break, ISO 527-3, % | 433 | 353 | 293 |
| Tear Strength, DIN 53543, N/mm | 1.25 | 1.37 | 0.93 |
| Ball Rebound, ASTM D3574, % | 39 | 39 | 43 |
| Compression Set, ASTM D395, % | 38 | 36 | 33 |
| Shore A Hardness, ASTM D2240 | 4 | 5 | 6 |

Examples 4-A, 4-B and 4-C are made and tested in the same manner as Examples 1-A, 1-B and 1-C, respectively, except the antioxidant is omitted. Gel time is measured as before, and physical property testing is performed as before, with results as indicated in Table 4.

TABLE 4

| Test | Ex. 4-A | Ex. 4-B | Ex. 4-C |
|---|---|---|---|
| Gel time, minutes | 20-25 | 20-25 | 20-25 |
| Tensile Strength, ISO 527-3, N/mm² | 1.33 | 0.86 | 1.23 |
| Elongation at break, ISO 527-3, % | 339 | 243 | 353 |
| Tear Strength, DIN 53543, N/mm | 1.89 | 2.15 | 1.25 |
| Ball Rebound, ASTM D3574, % | 41 | 36 | 42 |
| Compression Set, ASTM D395, % | 30 | 34 | 30 |
| Shore A Hardness, ASTM D2240 | 9 | 7 | 9 |

1. A filled tire comprising a tire casing which is filled with an elastomeric filling material, wherein said elastomeric filling material includes a polyurethane or polyurethane-urea elastomer extended with a C₁-C₄ alkyl ester of one or more fatty acids, wherein the polyurethane or polyurethane-urea elastomer is formed by curing within the tire casing a reactive composition that includes at least one organic polyisocyanate, at least one high equivalent weight polyol, and at least C₁-C₄ alkyl ester of one or more fatty acids, and the isocyanate index is from 70 to 130.

2. The filled tire of claim 1, wherein the C₁-C₄ alkyl ester of one or more fatty acids is an ester of a mixture of the constituent fatty acids of one or more vegetable oils.

3. The filled tire of claim 1, wherein the C₁-C₄ alkyl ester of one or more fatty acids is a methyl ester.

4. (canceled)

5. The filled tire of claim 1, wherein at least a portion of the high equivalent weight polyol is a polyether polyol.

6. The filled tire of claim 1, wherein at least a portion of the high equivalent weight polyol is derived from a vegetable oil.

7. The filled tire of claim 6 wherein the high equivalent weight polyol derived from a vegetable oil is a hydroxymethyl-containing polyester polyol.

8. A process for preparing a filled tire according to claim 1, comprising introducing into a tire casing a reactive composition that contains a C₁-C₄ alkyl ester of one or more fatty acids, and curing said reactive composition inside the tire casing to form an elastomeric polyurethane or polyurethane-urea elastomer extended with the C₁-C₄ alkyl ester of one or more fatty acids, and the isocyanate index is from 70 to 130.

9. The process of claim 8 wherein the reactive composition containing includes at least one organic polyisocyanate and at least one high equivalent weight polyol.

10. The process of claim 9, wherein at least a portion of the high equivalent weight polyol is a polyether polyol.

11. The process of claim 9, wherein at least a portion of the high equivalent weight polyol is derived from a vegetable oil.

12. The process of claim 11 wherein the high equivalent weight polyol derived from a vegetable oil is a hydroxymethyl-containing polyester polyol.

13. The process of claim 8, wherein the C₁-C₄ alkyl ester of one or more fatty acids is an ester of a mixture of constituent fatty acids of one or more vegetable oils.

14. The process of claim 8, wherein the C₁-C₄ alkyl ester of one or more fatty acids is a methyl ester.

15. The process of claim 8, wherein the reactive composition includes a polyisocyanate-terminated prepolymer which is made by a process comprising (a) blending an organic polyisocyanate with a C₁-C₄ alkyl ester of one or more fatty acids, (b) exposing the resulting blend to conditions sufficient to cause the organic isocyanate to react with hydroxyl-containing species in the C₁-C₄ alkyl ester of one or more fatty acids, and, simultaneously with or after step (b), (c) reacting the organic isocyanate with at least one polyol that has a hydroxyl equivalent weight of at least 300 to form the isocyanate-terminated prepolymer.

16. A process for making a polyisocyanate-terminated prepolymer, comprising (a) blending an organic polyisocyanate with a C₁-C₄ alkyl ester of one or more fatty acids, (b) exposing the resulting blend to conditions sufficient to cause the organic isocyanate to react with hydroxyl-containing species in the C₁-C₄ alkyl ester of one or more fatty acids, and, simultaneously with or after step (b), (c) reacting the organic isocyanate with at least one polyol that has a hydroxyl equivalent weight of at least 300 to form the isocyanate-terminated prepolymer.
